(19) United States
(12) Patent Application Publication
(10) Pub. No.: US 2026/0227971 A1
(43) Pub. Date: Aug. 6, 2026

(54) SYSTEMS AND METHODS FOR A SCRIPTING CODING ASSISTANT

(71) Applicant: Kinaxis Inc., Ottawa (CA)

(72) Inventors: Marin Creanga, Ottawa (CA); Arslan Shahid, Ottawa (CA); Jian Wu, Ottawa (CA)

(73) Assignee: Kinaxis Inc., Ottawa, ON (CA)

(21) Appl. No.: 19/466,683

(22) Filed: Feb. 2, 2026

Related U.S. Application Data
(60) Provisional application No. 63/754,186, filed on Feb. 5, 2025.

(51) Int. Cl. G06F 8/36; G06F 16/242

(52) U.S. Cl. CPC G06F 8/36; G06F 16/2425

(57) ABSTRACT

A coding assistant for scripting within a user interface of a platform, in which the platform uses customized functions and context. Systems and methods avoid bias (towards generic) functions), verbose and inefficient code, incorrect logic and hallucinations, by using query understanding, information retrieval, code generation, code quality assessment and code revision.

This application claims priority on U.S. Provisional Patent Application 63/754,186 filed on Feb. 5, 2025, which is incorporated herein in its entirety, by reference.

### BACKGROUND

A User Interface (UI) of a platform is designed to offer users a comprehensive and interactive experience. One feature of the UI is its robust scripting capabilities, which is built using a scripting language. These scripting capabilities allow users to create custom scripts that can automate tasks, manipulate data, and enhance the overall functionality of the UI. Examples of a scripting language include JavaScript®, TypeScript, Python, R, and the like.

To facilitate this, the UI provides a rich set of proprietary functions specifically tailored to the unique requirements and operations within the platform. These proprietary functions are designed to make it easier for users to script complex operations efficiently and accurately.

With the advent of publicly available coding assistants (or “co-pilots”), there has been a significant increase in the use of Artificial Intelligence (AI) to assist in writing code. These coding co-pilots are trained on vast amounts of publicly available code, which predominantly includes generic functions and libraries. However, this poses a significant challenge when it comes to scripting within a UI, as described above.

These publicly available coding assistants lack awareness of the proprietary functions and specific context of the platforms. As a result, when a user attempts to leverage these AI-powered coding assistants for scripting within a UI of a platform that employs a specific scripting language, several problems arise, such as bias, inefficient code, and hallucinations. These are summarized as follows.

Bias towards generic functions: AI models are heavily biased towards using generic scripting language functions. They tend to suggest and complete code snippets that do not leverage proprietary functions, which are crucial for efficient and correct scripting in a supply chain context.

Verbose and inefficient code: due to the lack of awareness about the proprietary functions within the platform, the code suggested by these AI models often becomes excessively verbose. Users end up writing more code than necessary, which can lead to inefficiencies and increased complexity.

Incorrect logic and hallucinations: perhaps the most critical issue is the incorrect logic often introduced by these AI models. They can misunderstand the context or misuse the functions, leading to what is known as “hallucinations”—where the AI generates code that appears plausible but is fundamentally incorrect or nonsensical within the given context.

### BRIEF SUMMARY

Systems and methods disclosed herein address the several problems that arise when attempting to leverage AI-powered coding assistants for scripting within a UI of a platform (that employs a specific scripting language).

In one aspect, a computing apparatus is provided, that includes a processor. The computing apparatus also includes a memory storing instructions that, when executed by the processor, configure the apparatus to: receive a user query; deduce user intent within the user query; retrieve information related to the user query from a pre-built knowledge base; generate a code; assess quality of the code; and where the code quality is unsatisfactory, revise the code.

When deducing user intent within the user query, the apparatus may be further configured to: extract main keywords from the user query and a chat history; and generate a generated query for information retrieval. When retrieving information related to the user query from the prebuilt knowledge base, the apparatus may be further configured to: create a vector key for lookup in the prebuilt knowledge base based on the user intent and user text; and use the vector key to retrieve the information related to the user query from the prebuilt knowledge base. When generating the code, the apparatus may be further configured to: construct a complete code context, where the complete code context includes the code context, information from the prebuilt knowledge base and one or more script constraints; transmit the complete code context to a Large Language Model (LLM); and generate the code. When assessing the quality of the code, the apparatus may be further configured to: apply one or more syntax rules to the code, and check adherence to coding guidelines. When revising the code, the apparatus may be further configured to: incorporate an assessment of the code quality and a chat history; and correct at least one of a syntax error and a compliance issue identified in the assessment with the aid of one or more large language models. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive a user query; deduce user intent within the user query; retrieve information related to the user query from a pre-built knowledge base; generate a code; assess quality of the code; and where the code quality is unsatisfactory revise the code.

When deducing user intent within the user query, the computer may be further configured to: extract main keywords from the user query and a chat history; and generate a generated query for information retrieval. When retrieving information related to the user query from the prebuilt knowledge base, the computer may be further configured to: create a vector key for lookup in the prebuilt knowledge base based on the user intent and user text; and use the vector key to retrieve the information related to the user query from the prebuilt knowledge base. When generating the code, the computer may be further configured to: construct a complete code context, where the complete code context includes the code context, information from the prebuilt knowledge base and one or more script constraints; transmit the complete code context to a Large Language Model (LLM); and generate the code. When assessing the quality of the code, the computer may be further configured to: apply one or more syntax rules to the code; and check adherence to coding guidelines. When revising the code, the computer may be further configured to incorporate an assessment of the code quality and a chat history; and correct at least one of a syntax error and a compliance issue identified in the assessment with the aid of one or more large language models. Other technical features may be readily apparent to one skilled in the art from the following figures, descriptions, and claims.

In one aspect, a computer-implemented method is provided, that includes: receiving, by a processor, a user query; deducing, by the processor, user intent within the user query; retrieving, by the processor, information related to the user query from a pre-built knowledge base; generating, by the processor, a code; assessing, by the processor, quality of the code; and where the code quality is unsatisfactory, revising, by the processor, the code.

When deducing user intent within the user query, the computer-implemented method may further include: extracting, by the processor, main keywords from the user query and a chat history; and generating, by the processor, a generated query for information retrieval. When retrieving information related to the user query from the prebuilt knowledge base, the computer-implemented method may further include: creating, by the processor, a vector key for lookup in the prebuilt knowledge base based on the user intent and user text; and using, by the processor, the vector key to retrieve the information related to the user query from the prebuilt knowledge base. When generating the code, the computer-implemented method may further include: constructing, by the processor, a complete code context, the complete code context including the code context, information from the prebuilt knowledge base and one or more scripting constraints; transmitting, by the processor, the complete code context to a Large Language Model (LLM); and generating, by the processor, the code. When assessing the quality of the code, the computer-implemented method may further include: applying, by the processor, one or more syntax rules to the code; and checking, by the processor, adherence to coding guidelines. When revising the code, the computer-implemented method may further include: incorporating, by the processor, an assessment of the code quality and a chat history; and correcting, by the processor, at least one of a syntax error and a compliance issue identified in the assessment with the aid of one or more large language models. Other technical features may be readily apparent to one skilled in the art from the following figures, descriptions, and claims.

In one aspect, a computing apparatus for building a scripting knowledge base of a platform is provided. The computing apparatus includes a processor. The computing apparatus also includes a memory storing instructions that, when executed by the processor, configure the apparatus to: extract text from scripting documentation related to the platform, to produce a text document; chunk the text document based on one or more delimiters to produce a plurality of chunks; and sequentially process each chunk of the plurality of chunks separately. The computing apparatus also includes a memory storing instructions that, when executed by the processor, configure the apparatus to: create a vector associated with a respective chunk; and persist the vector and the respective chunk.

With respect to the computing apparatus, the scripting knowledge base may be a database that includes: information about proprietary functions of the platform, and one or more usage contexts of the proprietary functions. In addition, the scripting knowledge base may be implemented as a vector database. Furthermore, the one or more delimiters may include at least one of: a paragraph break, a sentence boundary, a heading, a subheading and a bullet point. Other technical features may be readily apparent to one skilled in the art from the following figures, descriptions, and claims.

In one aspect, a non-transitory computer-readable storage medium for building a scripting knowledge base of a platform is provided. The computer-readable storage medium includes instructions that when executed by a computer, cause the computer to: extract text from scripting documentation related to the platform, to produce a text document; chunk the text document based on one or more delimiters to produce a plurality of chunks; and sequentially process each chunk of the plurality of chunks separately. The computing apparatus also includes a memory storing instructions that, when executed by the processor, configure the apparatus to: create a vector associated with a respective chunk; and persist the vector and the respective chunk.

With respect to the non-transitory computer-readable storage medium, the scripting knowledge base may be a database that includes: information about proprietary functions of the platform, and one or more usage contexts of the proprietary functions. In addition, the scripting knowledge base may be implemented as a vector database. Furthermore, the one or more delimiters may include at least one of: a paragraph break, a sentence boundary, a heading, a subheading and a bullet point. Other technical features may be readily apparent to one skilled in the art from the following figures, descriptions, and claims.

In one aspect, a computer-implemented method for building a scripting knowledge base of a platform is provided. The method includes: extracting, by a processor, text from scripting documentation related to the platform, to produce a text document; chunking, by the processor, the text document based on one or more delimiters to produce a plurality of chunks; sequentially processing, by the processor, each chunk of the plurality of chunks separately by: creating, by the processor, a vector associated with a respective chunk; and persisting, by the processor, the vector and the respective chunk.

With respect to the computer-implemented method, the scripting knowledge base may be a database that includes: information about proprietary functions of the platform, and one or more usage contexts of the proprietary functions. In addition, the scripting knowledge base may be implemented as a vector database. Furthermore, the one or more delimiters may include at least one of: a paragraph break, a sentence boundary, a heading, a subheading and a bullet point. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for a scripting coding assistant, in accordance with one embodiment.

FIG. 2 illustrates a block diagram in accordance with one embodiment.

FIG. 3 illustrates a block diagram for query understanding in accordance with one embodiment

FIG. 4 illustrates a block diagram for building a scripting knowledge base of a platform, in accordance with one embodiment.

FIG. 5 illustrates a block diagram for information retrieval in accordance with one embodiment.

FIG. 6 illustrates a block diagram for code generation in accordance with one embodiment.

FIG. 7 illustrates a block diagram for assessing code quality in accordance with one embodiment.

FIG. 8 illustrates a block diagram for revising code in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

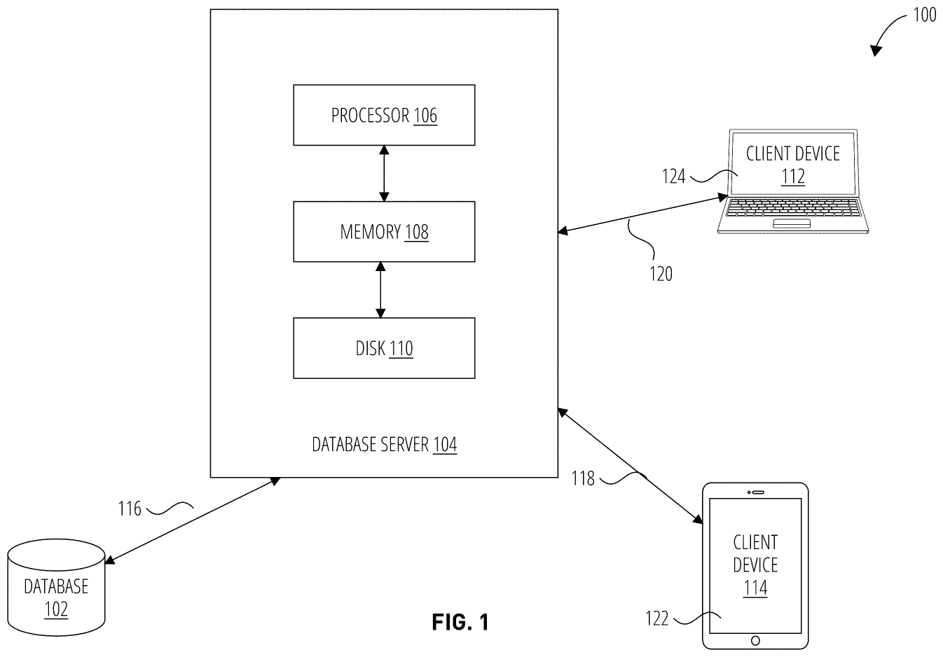

FIG. 1 illustrates an example of a system 100 for a scripting coding assistant, in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

In the present disclosure, the terms “process” and “algorithm” are used interchangeably, and may refer to a set of steps performed in relation to an in-memory database, such as a versioned database. As referred to herein, for example, a deterministic process may be considered to be equivalent to a deterministic algorithm. A deterministic algorithm always produces the same output given a particular input. For example, an algorithm that always returns an output of Y with an input of X is deterministic. So, every time there is an input of X, it is known that the answer is Y. The result does not have to be unique, for example an input of Q can also return an output of Y, just deterministic. For a deterministic algorithm, once the input is known, the answer or output is already known, and it is not necessary to send the input to the algorithm at all.

In some implementations, a server memory may store an in-memory database as well as calculated results from processes or algorithms that are executed in relation to contents of the in-memory database. In some implementations, the calculated results may include about half of the server memory.

Reference to “in-memory” storage may refer to a server memory associated with database server 104, which may include memory 108 and/or database 102. Reference to “on-disk” storage may refer to disk 110 and/or other disks, for example disks associated with cloud storage.

A technical solution developed to address the challenges of scripting within a UI of a platform, can include a custom large language model (LLM) agent that can utilize Retrieval-Augmented Generation (RAG). This solution can provide accurate, efficient, and contextually relevant code suggestions tailored to the proprietary functions of the UI of a platform.

Systems and methods disclosed herein can include the following elements: query understanding, information retrieval, code generation, code quality assessment and code revision. Systems and methods disclosed herein address issues of bias, inefficient code, verbose code, hallucinations and incorrect logic as follows. This combination of elements and steps creates a powerful and tailored coding assistant for the UI of a platform, capable of generating accurate, efficient, and contextually relevant code.

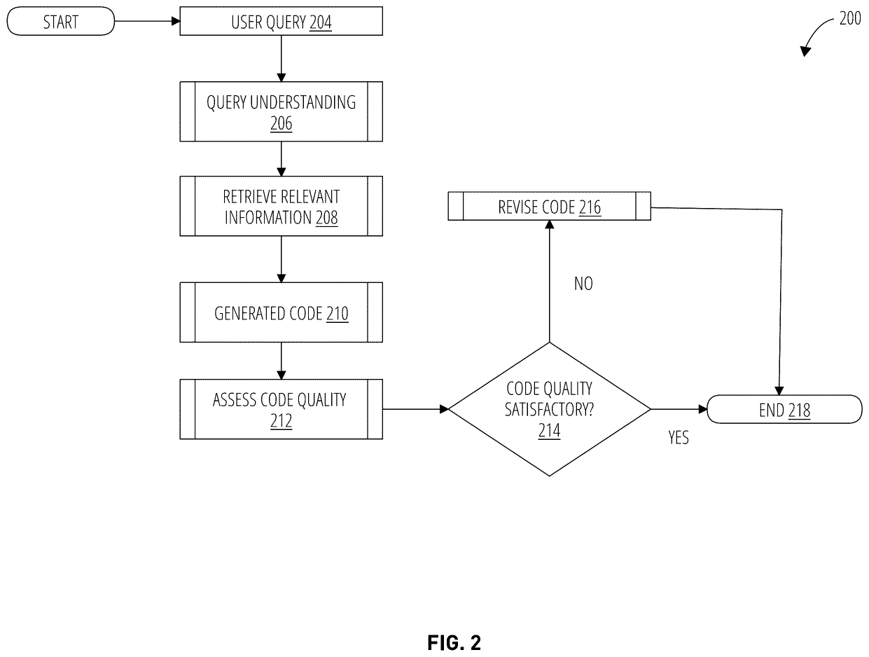

FIG. 2 illustrates a block diagram 200 in accordance with one embodiment.

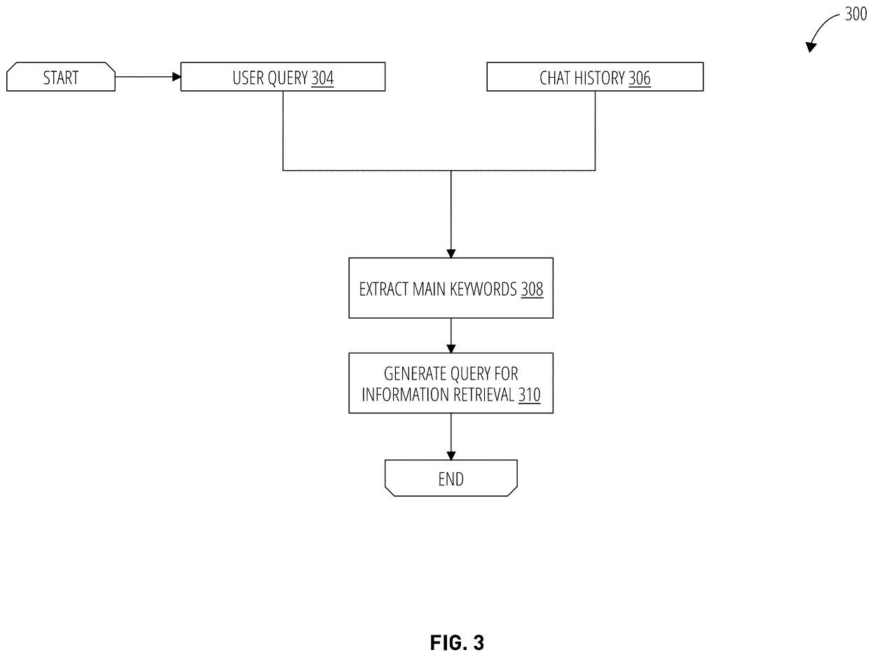

A user query is provided as input at block 204. Analysis of the user query is performed at subroutine block 206 to understand the context and the specific task that the user is trying to accomplish. This step ensures that the system accurately interprets a user's needs. That is, subroutine block 206 serves to provide query understanding. An embodiment of subroutine block 206 is further discussed in relation to FIG. 3.

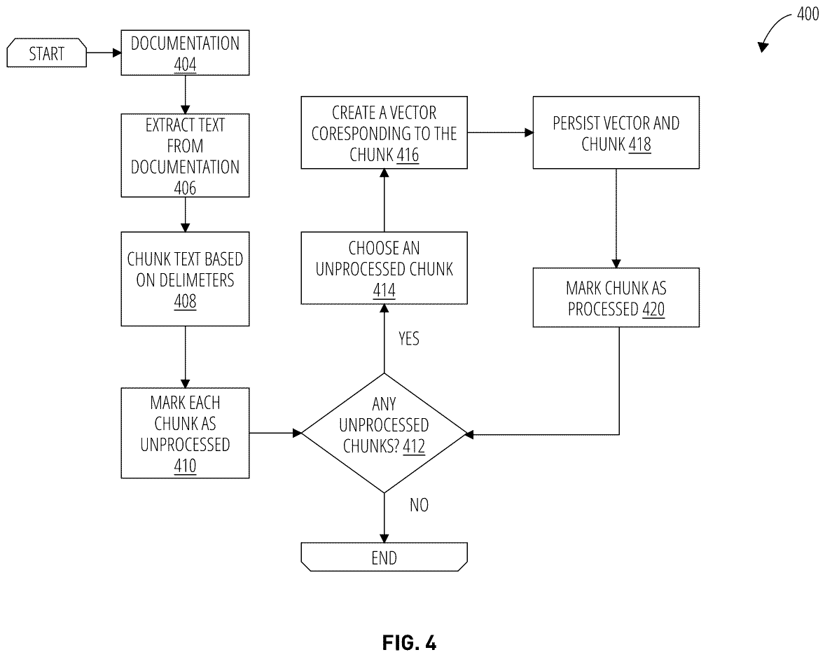

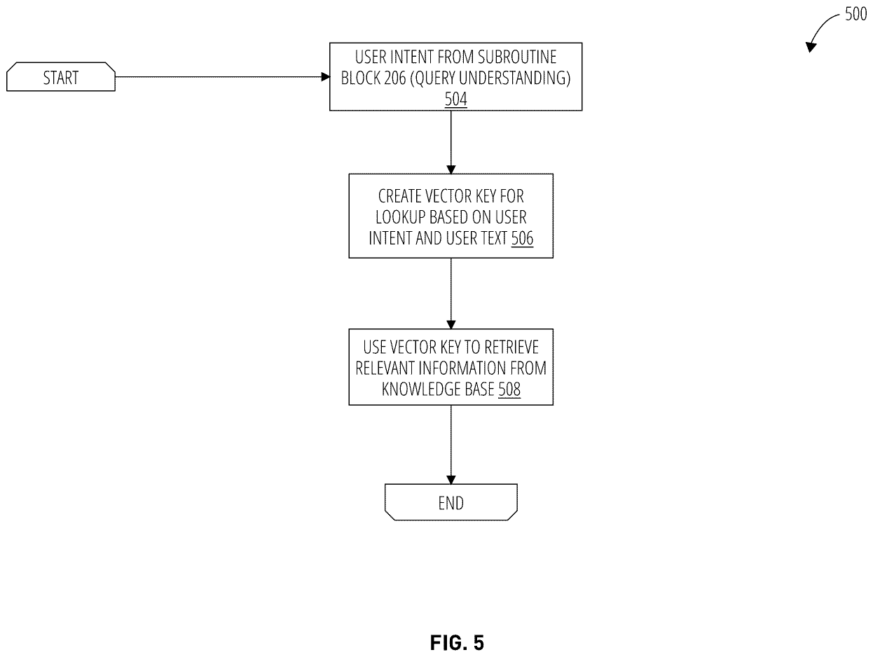

Next, information retrieval is performed via subroutine block 208. Relevant documentation, examples, and descriptions of proprietary functions can be retrieved from a pre-built knowledge base related to scripting within the platform. This knowledge base can be designed for efficient retrieval of relevant information related to scripting within the platform. An embodiment for building a knowledge base related to scripting within the platform, is discussed in relation to FIG. 4. An embodiment of subroutine block 208 (information retrieval) is further discussed in relation to FIG. 5.

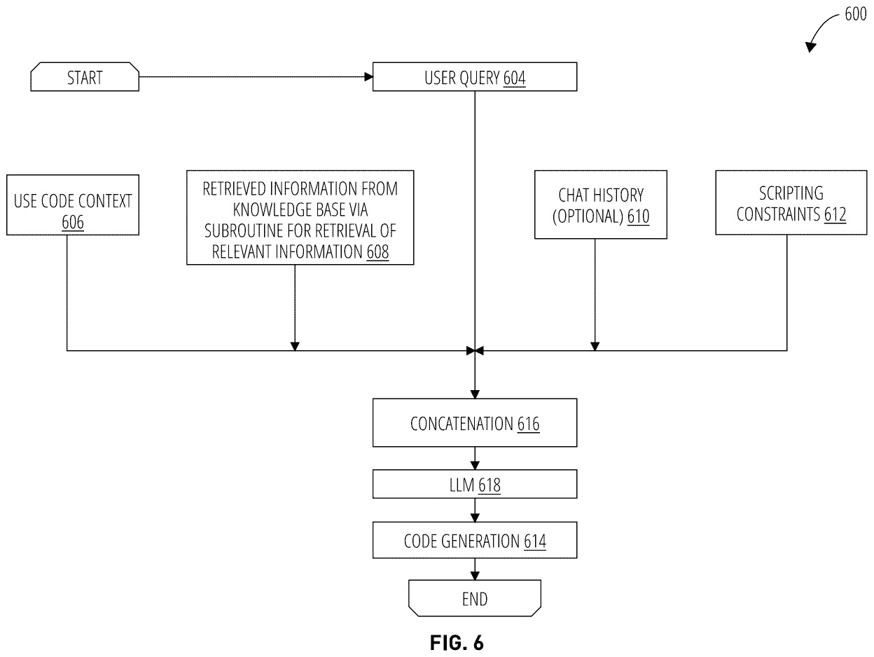

Next, at subroutine block 210, retrieved information is used to augment the input to the language model. By providing the language model with detailed context, the system ensures that generated code suggestions are accurate and relevant. An embodiment of subroutine block 210 (code generation) is further discussed in relation to FIG. 6.

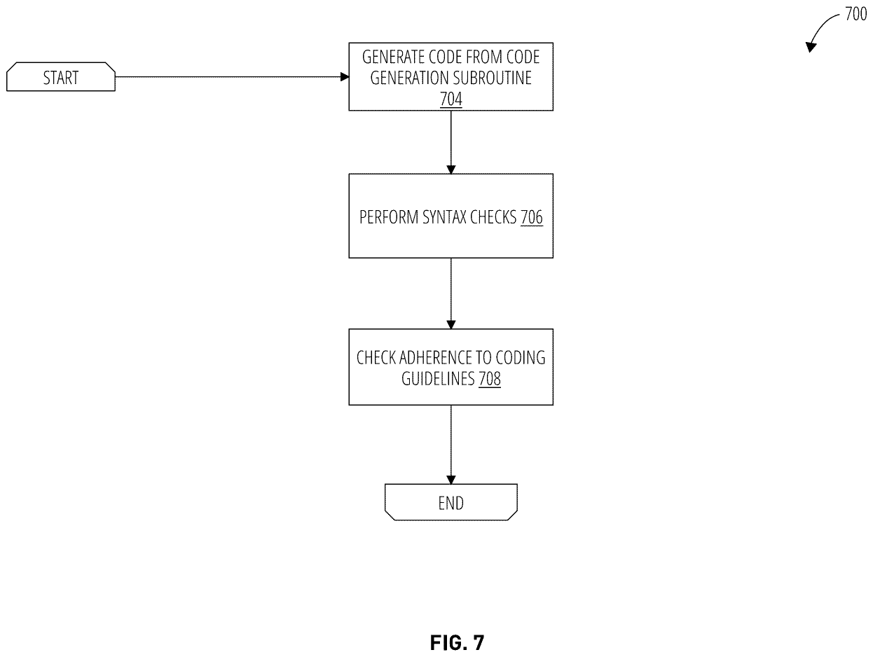

Next, at subroutine block 212, tools and libraries are utilized that automatically check the generated code for syntax errors. This ensures that the code is syntactically correct and can be executed without issues. This step ensures that the generated code adheres to predefined coding standards and guidelines specific to coding guide. This includes following best practices for naming conventions, code structure, and documentation. An embodiment of subroutine block 212 (code quality assessment) is further discussed in relation to FIG. 7. If the code quality is satisfactory ('yes' at decision block 214), the process subsequently ends at 218.

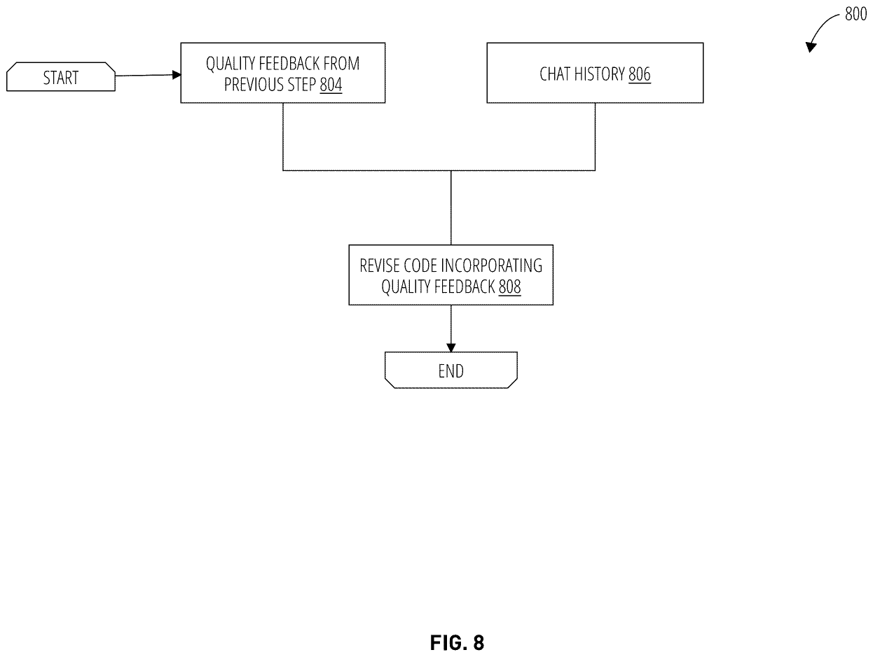

If the code quality is not satisfactory ('no′ at decision block 214), then the code is revised at subroutine block 216, using the feedback from syntax checking and coding standards compliance, in order to correct any identified issues in the generated code. An embodiment of subroutine block 216 (code revision) is further discussed in relation to FIG. 8. The process subsequently ends at 218.

Bias towards generic functions can be overcome by retrieving and incorporating detailed information about proprietary functions of the platform. In this manner, a technical solution ensures that the language model suggests code that leverages these proprietary functions, rather than defaulting to generic functions of the scripting language.

Verbose and inefficient code can be reduced as follows. With contextually accurate information, systems and methods disclosed herein generate concise and efficient code suggestions, avoiding the verbosity and complexity that can arise from a lack of awareness about proprietary functions.

Incorrect logic and hallucinations can be minimized as follows. By providing the language model with the correct context and detailed descriptions of proprietary functions, there is a significant reduction of risk of generating incorrect logic or nonsensical code, known as “hallucinations.”

FIG. 3 illustrates a block diagram 300 for query understanding in accordance with one embodiment. Query understanding analyzes a user's query to understand context and capture user intent.

The process begins with input of a user's query at 304, along with any chat history (at block 306). Next, at block 308, keywords from both sources are extracted. Subsequently, at block 310, a query is generated for information retrieval. Block 310 includes creation of a query string from the keywords (extracted at block 308) that captures the user's intent. This step involves understanding the specific task the user is trying to accomplish and the context of their request.

As an example, a user provides the following query (at block 304): “Create a scenario that will automatically get updated when its parent is modified. The new scenario name is “myScenario” and the parent scenario is “Baseline” and its scope is public.” A generated query string (at block 310) can be: “Create scenario ‘myScenario’ with automatic updates from parent ‘Baseline’ in public scope”. This generated query string is used for information retrieval, for example, in subroutine block 208 in FIG. 2 and, for example, in FIG. 5.

FIG. 4 illustrates a block diagram 400 for building a scripting knowledge base of a platform, in accordance with one embodiment.

A comprehensive scripting knowledge base can be constructed by processing all relevant scripting documents related to a scripting guide of the platform. This knowledge base can be a database that contains detailed information about the platform's proprietary functions and their appropriate usage contexts. This knowledge base may be implemented as a vector database, enabling efficient and accurate retrieval of information based on a user's intent. The quality and structure of a scripting knowledge base may be foundational for the system's overall accuracy. An extensive knowledge base can be developed by compiling and processing all pertinent scripting documents. This knowledge base facilitates efficient and precise retrieval of information based on a user's needs.

As shown in FIG. 4, documentation is provided at block 404. Text is extracted from the documentation at block 406. Subsequently, at block 408, the text document is chunked based on delimiters. This step allows for each chunk to be processed separately in subsequent steps. Examples of delimiters include paragraph breaks, sentence boundaries, headings and subheadings, bullet points, and the like.

Each chunk is marked as unprocessed at block 410. At the first go-around (‘yes’ at decision block 412), an unprocessed chunk is selected at block 414. A vector, associated with the chunk, is created at block 416. The term “vector” refers to an entry in the pre-built knowledge base that can be queried based on its relevance to a user question. The vector and its corresponding chunk are persisted at block 418, and the chunk is marked as processed at block 420. If there are any remaining unprocessed chunks ('yes' at decision block 412), the process repeats until no more chunks are left to process ('no′ at decision block 412).

FIG. 5 illustrates a block diagram 500 for information retrieval in accordance with one embodiment. Once the query intent is understood, relevant information can be retrieved from a pre-built knowledge base. The pre-built knowledge base can be constructed, for example, in accordance with the embodiment illustrated in FIG. 4. Information retrieval includes retrieval of relevant documentation, examples, and descriptions from a pre-built knowledge base containing detailed information about the platform's proprietary functions and their appropriate usage contexts.

User intent is obtained from the query understanding subroutine (an embodiment of which is illustrated in FIG. 3). The user intent is provided (at block 504) to create a vector key for lookup, based on the user intent and user text, at block 506. The vector key is then used to retrieve information from the pre-built knowledge base at block 508. Retrieved information can include relevant documentation, examples, and descriptions from the pre-built knowledge base. The retrieval process ensures access to all necessary information. For example, if a user query is about creation of a scenario, an information retrieval step can retrieve help documents and coding examples for scenario creation, in relation to the platform's proprietary functions and their appropriate usage contexts.

FIG. 6 illustrates a block diagram 600 for code generation in accordance with one embodiment. In the embodiment shown in FIG. 6, code generation can combine a user query, the current code context, scripting constraints, the retrieved information and chat history in a sophisticated manner for construction of a complete context for code generation.

An LLM, now equipped with the necessary context, can generate code suggestions to provide code that is specifically tailored to the platform's scripting language and leverages the platform's proprietary functions effectively. This step produces highly accurate and relevant code completions.

With reference to FIG. 6, a user query is provided at block 604. A complete context for code generation can be constructed using the following: code context (block 606), information from a pre-built knowledge base (block 608), chat history (block 610) and scripting constraints (block 612). Other sources can be used. Use of the chat history is optional in embodiments where a user is confined to not having a conversation, nor asking follow-up questions. However, minimization of hallucinations and errors of logic can be compromised when there is only a single interaction between a user and the system.

At block 614, information from the various sources is concatenated together at block 616 and passed onto a large language model (LLM) at block 618 for completion. With the augmented context, an LLM generates code suggestions, at block 614, that are specifically tailored to the platform's scripting language. These suggestions leverage the platform's proprietary functions, ensuring that the generated code is efficient and correct.

As an example of code generation, a user query to create a scenario can result in the following code:

• function main( ) {
•
• var scenarioName = “myScenario”;
• createScenario(scenarioName, “Baseline”, “Public”);
•
• }
•
• function createScenario(name, parentName, parentScope) {
• var parent = { name: parentName, scope: parentScope };
• rapidResponse.scenarios.create(name, parent, {autoUpdate: true});
• }

FIG. 7 illustrates a block diagram 700 for code quality assessment in accordance with one embodiment. Quality of the generated code can be evaluated by applying syntax rules to identify any issues and by ensuring the code complies with predefined coding guidelines. This includes checking for syntax errors and adherence to coding standards. The assessment ensures that the code is both correct and executable.

Code is generated from a code generation subroutine (see FIG. 6, for example), ready for evaluation at block 704. Syntax rules can be applied at block 706 to identify any issues with the generated code. At 708, the code can be evaluated against coding guidelines to ensure it complies with these standards.

For example, if the code generation produced the following code:
console.log( . . . );
it will be identified as an issue as the coding guidelines mention using a platform-specific function for logging.
FIG. 8 illustrates a block diagram 800 for revising code in accordance with one embodiment. Where the code assessment is unsatisfactory, the generated code is revised using feedback generated from the code assessment subroutine (an embodiment of which is illustrated in FIG. 7).

Feedback obtained from the code quality assessment (block 804) is used, along with the chat history (block 806) to make revisions to the generated code. This involves addressing any syntax errors and/or compliance issues identified during the assessment. LLMs can be employed to assist in refining the code at block 808.

Based on the feedback from the code quality assessment, the system revises the generated code. This involves using large language models (LLMs) to assist in refining the code by automatically correcting errors, optimizing the code, and ensuring it adheres to best practices. The revision process may involve multiple iterations, incorporating user feedback and chat history, and customizing the revisions to meet specific user requirements.

In the example above, where console.log( . . . ) was included in the generated code, the revised code would replace this line with:
platformname.console.writeLine( . . . );

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
receive a user query;
deduce user intent within the user query;
retrieve information related to the user query from a pre-built knowledge base;
generate a code;
assess quality of the code; and
where the code quality is unsatisfactory, revise the code.

2. The computing apparatus of claim 1, wherein when deducing user intent within the user query, the apparatus is further configured to:
extract main keywords from the user query and a chat history; and
generate a generated query for information retrieval.

3. The computing apparatus of claim 1, wherein when retrieving information related to the user query from the prebuilt knowledge base, the apparatus is further configured to:
create a vector key for lookup in the prebuilt knowledge base based on the user intent and user text; and
use the vector key to retrieve the information related to the user query from the prebuilt knowledge base.

4. The computing apparatus of claim 1, wherein when generating the code, the apparatus is further configured to:
construct a complete code context, the complete code context comprising the code context, information from the prebuilt knowledge base and one or more script constraints;
transmit the complete code context to a Large Language Model (LLM); and
generate the code.

5. The computing apparatus of claim 1, wherein when assessing the quality of the code, the apparatus is further configured to:
apply one or more syntax rules to the code; and
check adherence to coding guidelines.

6. The computing apparatus of claim 1, wherein when revising the code, the apparatus is further configured to:
incorporate an assessment of the code quality and a chat history; and
correct at least one of a syntax error and a compliance issue identified in the assessment with the aid of one or more large language models.

7. A non-transitory computer-readable storage medium, the computer-readable storage medium including instructions that when executed by a computer, cause the computer to:
receive a user query;
deduce user intent within the user query;
retrieve information related to the user query from a pre-built knowledge base;
generate a code;
assess quality of the code; and
where the code quality is unsatisfactory, revise the code.

8. The non-transitory computer-readable storage medium of claim 7, wherein when deducing user intent within the user query, the computer is further configured to:
extract main keywords from the user query and a chat history; and
generate a generated query for information retrieval.

9. The non-transitory computer-readable storage medium of claim 7, wherein when retrieving information related to the user query from the prebuilt knowledge base, the computer is further configured to:
create a vector key for lookup in the prebuilt knowledge base based on the user intent and user text; and
use the vector key to retrieve the information related to the user query from the prebuilt knowledge base.

10. The non-transitory computer-readable storage medium of claim 7, wherein when generating the code, the computer is further configured to:
construct a complete code context, the complete code context comprising the code context, information from the prebuilt knowledge base and one or more script constraints;
transmit the complete code context to a Large Language Model (LLM); and
generate the code.

11. The non-transitory computer-readable storage medium of claim 7, wherein when assessing the quality of the code; the computer is further configured to:
apply one or more syntax rules to the code; and
check adherence to coding guidelines.

12. The non-transitory computer-readable storage medium of claim 7, wherein when revising the code, the computer is further configured to:
incorporate an assessment of the code quality and a chat history; and
correct at least one of a syntax error and a compliance issue identified in the assessment with the aid of one or more large language models.

13. A computer-implemented method comprising:
receiving, by a processor, a user query;
deducing, by the processor, user intent within the user query;
retrieving, by the processor, information related to the user query from a pre-built knowledge base;
generating, by the processor, a code;
assessing, by the processor, quality of the code; and
where the code quality is unsatisfactory:
revising, by the processor, the code.

14. The computer-implemented method of claim 13, wherein deducing user intent within the user query comprises:
extracting, by the processor, main keywords from the user query and a chat history; and
generating, by the processor, a generated query for information retrieval.

15. The computer-implemented method of claim 13, wherein retrieving information related to the user query from the prebuilt knowledge base comprises:
creating, by the processor, a vector key for lookup in the prebuilt knowledge base based on the user intent and user text; and
using, by the processor, the vector key to retrieve the information related to the user query from the prebuilt knowledge base.

16. The computer-implemented method of claim 13, wherein generating the code comprises:
constructing, by the processor, a complete code context, the complete code context comprising the code context, information from the prebuilt knowledge base and one or more scripting constraints;
transmitting, by the processor, the complete code context to a Large Language Model (LLM); and
generating, by the processor, the code.

17. The computer-implemented method of claim 13, wherein assessing the quality of the code comprises:
applying, by the processor, one or more syntax rules to the code; and
checking, by the processor, adherence to coding guidelines.

18. The computer-implemented method of claim 13, wherein revising the code comprises:
incorporating, by the processor, an assessment of the code quality and a chat history; and
correcting, by the processor, at least one of a syntax error and a compliance issue identified in the assessment with the aid of one or more large language models.
